(19) United States
(12) Patent Application Publication
(10) Pub. No.: US 2024/0265413 A1
(43) Pub. Date: Aug. 8, 2024

(54) STABLE CRYPTOGRAPHIC CARBON SYNTHETIC ASSET FOR A REGENERATIVE ECOSYSTEM

(71) Applicant: PARISII, INC., San Juan, PR (US)

(72) Inventor: Jason Ryan Cooner, Pinson, AL (US)

(21) Appl. No.: 18/433,244

(22) Filed: Feb. 5, 2024

Related U.S. Application Data
(60) Provisional application No. 63/443,396, filed on Feb. 5, 2023.
(60) Provisional application No. 63/452,427, filed on Mar. 15, 2023.

(51) Int. Cl. G06Q 30/0202; G06Q 30/018

(52) U.S. Cl. CPC G06Q 30/0202; G06Q 30/018

(57) ABSTRACT

Methods for operating a stable carbon synthetic asset for a regenerative ecosystem include providing a carbon reflex index implemented on a blockchain. The carbon reflex index includes a redemption value that corresponds to a market value of the carbon reflex index. It is determined that the market value of the carbon reflex index has increased. A proportional feedback value is determined based on the redemption value and the market value. An integral feedback value is determined based on historical deviations of the redemption value. A redemption rate of the carbon reflex index is determined based on the proportional feedback value and the integral feedback value. It is determined that a difference between the market value and the redemption value is less than a threshold difference. The redemption value is broadcast to computer devices communicably coupled to the blockchain.

### CLAIM FOR PRIORITY

This application claims priority to and the benefit of U.S. Provisional Patent Application No. 63/452,427, entitled “PARYS: A STABLE AND TRANSPARENT CARBON SYNTHETIC COLLATERAL FOR THE REGENERATIVE FINANCE ECOSYSTEM,” filed on Mar. 15, 2023 and U.S. Provisional Patent Application No. 63/443,396, entitled “PARYS: A STABLE AND TRANSPARENT CARBON ALLOWANCE COLLATERAL FOR THE REGENERATIVE FINANCE ECOSYSTEM,” filed on Feb. 5, 2023, both of which are incorporated herein by reference in their entireties.

### TECHNICAL FIELD

The disclosure relates generally to cryptographic carbon-based assets for regenerative ecosystems, and in particular to cryptographic computer-implemented methods and systems for operating carbon reflex indexes implemented on blockchains.

### BACKGROUND

There is presently a $130 Trillion Climate Finance gap related to implementing the Paris climate change mitigation agreement through 2050 that is unlikely to be addressed by historical Financial Institution based stock and bond issuance and investment alone. Hence, conventional systems to address climate change require a bridging of existing financial mechanisms with Web3. Web3, otherwise called Decentralized Finance, now including Regenerative Finance, is a path to NetZero by 2050. Existing financial means are unable to deliver such results. There is therefore a need for a governance-reduced decentralized protocol that automatically reacts to market forces in order to modify the target value of its native collateralized asset, carbon.

### SUMMARY

Some of the subject matter described herein includes a cryptographic computer-implemented method for operating a carbon reflex index implemented on a blockchain. The method includes providing, by a computer system communicably coupled to the blockchain, the carbon reflex index at a first time. The carbon reflex index includes a redemption value that corresponds to a market value of the carbon reflex index. At a second time later than the first time, it is determined that the market value of the carbon reflex index has increased. Responsive to determining that the market value of the carbon reflex index has increased, a proportional feedback value is determined based on the redemption value and the market value. The proportional feedback value is determined using a proportional-integral-derivative controller. The proportional feedback value causes the redemption value to reduce. An integral feedback value is determined based on historical deviations of the redemption value. The integral feedback value is determined using the proportional-integral-derivative controller. A redemption rate of the carbon reflex index is determined based on the proportional feedback value and the integral feedback value. The redemption rate causes the redemption value to reduce. At a third time later than the second time, it is determined that a difference between the market value and the redemption value is less than a threshold difference. The computer system broadcasts the redemption value to computer devices communicably coupled to the blockchain.

In some implementations, the carbon reflex index is configured to dampen volatility of a native carbon collateral of the carbon reflex index.

In some implementations, the proportional-integral-derivative controller is configured to maintain an equilibrium between the redemption value and the market value using the redemption rate.

In some implementations, each computer device of the computer devices is configured to claim an amount of a native carbon collateral of the carbon reflex index based on the redemption value.

In some implementations, a carbon-collateralized stablecoin based on a native carbon collateral of the carbon reflex index is minted using proof-of-stake minting. The proof-of-stake minting reduces greenhouse gas emissions compared to minting using digital mining.

In some implementations, a carbon-collateralized stablecoin that is fungible with a carbon allowance is minted.

### BRIEF DESCRIPTION OF THE DRAWINGS

FIG. 1 is a block diagram illustrating an example system for arbitrage valuation, in accordance with one or more embodiments of this disclosure.

FIG. 2 is a block diagram illustrating an example system implementing a stablecoin, in accordance with one or more embodiments of this disclosure.

FIG. 3 is a table illustrating example trading volumes in carbon markets, in accordance with one or more embodiments of this disclosure.

FIG. 4A is a graph illustrating an example relationship between market value and redemption value, in accordance with one or more embodiments of this disclosure.

FIG. 4B is a graph illustrating an example relationship between market value and redemption value, in accordance with one or more embodiments of this disclosure.

FIG. 5 is a flow diagram illustrating an example cryptographic computer-implemented process for operating a carbon reflex index implemented on a blockchain, in accordance with one or more embodiments of this disclosure.

FIG. 6 is a block diagram illustrating components of at least a portion of an exemplary blockchain system, in accordance with one or more embodiments of this disclosure.

FIG. 7 is a block diagram illustrating an example cryptographic wallet, in accordance with one or more embodiments of this disclosure.

FIG. 8 is a block diagram illustrating an example computer system, in accordance with one or more embodiments of this disclosure.

### DETAILED DESCRIPTION

Disclosed herein are methods, apparatuses, and systems for implementing a framework for building carbon reflex indexes. The carbon reflex indexes include cryptographic asset types that enable other carbon synthetics to flourish and establish key building blocks for the decentralized finance and regenerative finance industries. By leveraging existing European Union Allowances (EUAs) as Carbon Futures for collateralization, coupled with the Intercontinental Exchange European Union Allowance (ICEEUA) index for price discovery and fungibility, the methods disclosed herein can achieve improved results as a ReFi protocol. The carbon reflex indexes disclosed are a non-pegging to carbon collateral and improve monetary policy and related global governance.

The benefits and advantages of the disclosed embodiments include the reduction of greenhouse gas emissions caused by digital mining. The methods for Proof-of-Stake minting of the stablecoins disclosed eschew digital mining and prevent new greenhouse gas emissions. Further, the stablecoins disclosed are 1:1 fungible with a Carbon Allowance (designed to save the planet), which can be used for Paris Agreement compliance. The disclosed systems are designed to drive the price of carbon up naturally, to set a new/higher floor for carbon pricing worldwide incrementally over time. Thus, the disclosed systems reduce and prevent additional greenhouse gas emissions, and monitor, track, and verify greenhouse gas emission reductions. The disclosed apparatuses reward higher-quality greenhouse gas (GHG) Projects with better compensation and higher liquidity throughout their decades-long lifetime. The Carbon Synthetic disclosed herein is designed to increase in value over time, in fact adjusting for inflation and profits per government climate change policies in the pricing model itself. Further, the cryptographic asset disclosed herein is a carbon-collateralized “green Carbon Synthetic,” allowing the crypto exchanges to perform 100% of their global settlement with a truly green financing mechanism.

The disclosed methods related to carbon allowances further benefit from favorable supply and demand dynamics, political pressures and international investment in decarbonization. These factors should multiply the growth potential of carbon allowances, particularly if climate change targets become more ambitious than current net-zero goals.

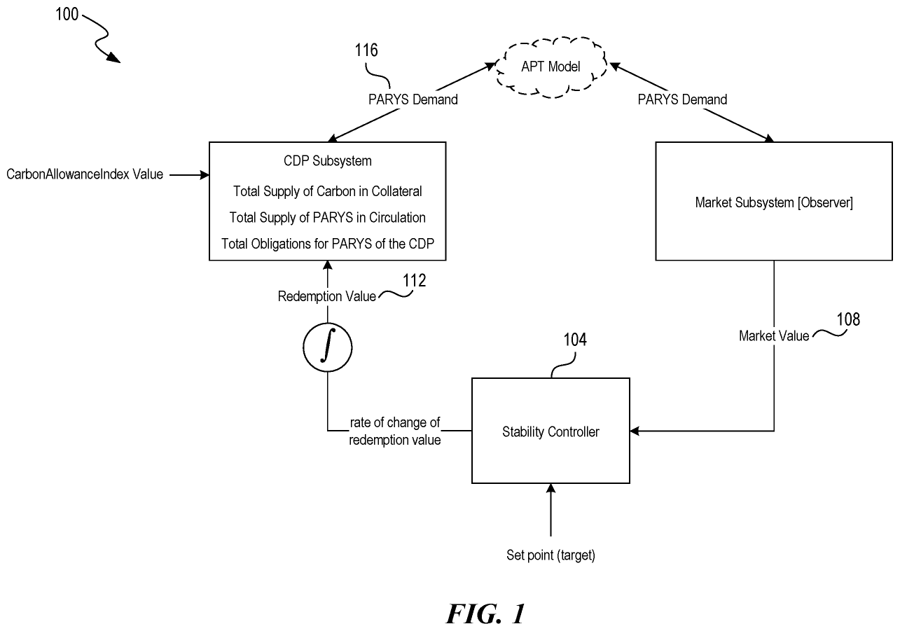

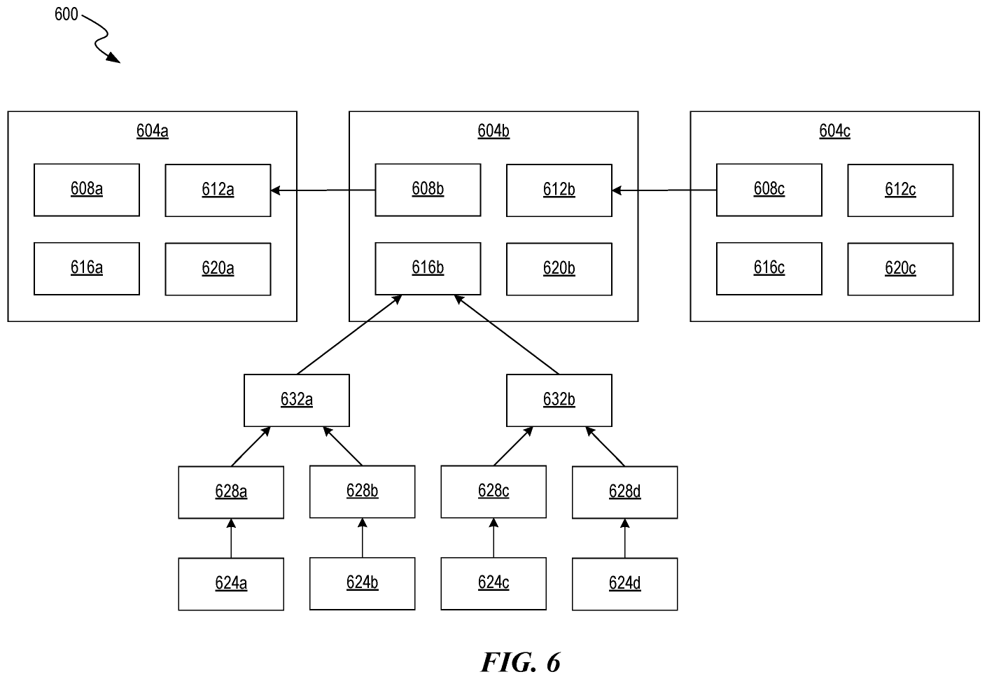

FIG. 1 is a block diagram illustrating an example computer system 100 for arbitrage valuation, in accordance with one or more embodiments of this disclosure. Computer system 100 includes a carbon disclosure project (CDP) subsystem, a market subsystem, and a stability controller 104. The computer system 100 is implemented using components of example computer system 600 illustrated and described in more detail with reference to FIG. 6. Likewise, embodiments of computer system 100 can include different and/or additional components or can be connected in different ways.

Carbon allowances—also called “emissions trading schemes”, or “cap and trade”—are sometimes described as the economist's solution to greenhouse gas emissions. They are tradeable government permits that allow polluters to pump carbon dioxide (CO2) into the atmosphere. Under these programs, polluters must surrender enough allowances to cover their pollution upon inspection. Governments ensure compliance, with large fines issued for non-compliance.

Further, emission trading schemes are the issuers of and marketplace for carbon allowances. They were introduced to help address climate change concerns and became more widely known after the Paris Agreement in 2015 when governments from around the world agreed to reach net-zero carbon emissions by 2050 to prevent global warming increasing by more than two degrees Celsius. According to the Organization for Economic Co-operation and Development (OECD), “broader use of emission trading systems (or of environmental taxation) would be one of the most efficient and effective ways of promoting green growth”-making them a vital tool in accomplishing these targets. The most regulated and enforceable type of emission trading scheme is the ‘cap-and-trade’ model. ‘Cap-and-trade’ schemes auction off carbon allowances to put a strict “cap” on the overall number of emissions which can be pumped into the atmosphere each year and incrementally lower the “cap” to work towards net-zero goals. The largest and most established trading schemes in the world follow this model. Each scheme has its nuances; however, the basic principles are similar across the board.

Emission trading scheme authorities hold an annual auction where polluters bid to purchase enough carbon allowances to see them through the year. The number of new allowances issued is reduced each year-creating a more competitive market, pushing up the price of CO2 and encouraging the adoption of clean energy. Participating organizations can also auction off their leftover allowances from the previous year. To ensure allowance limits are adhered to, trading scheme authorities conduct audits and enforce hefty fines.

The computer system 100 shown by FIG. 1 can be used to provide a carbon reflex index and/or a stablecoin (e.g., cryptographic asset 116 that is sometimes referred to as “PARYS”), which is a synthetic instrument designed, acquired, and held to emulate the characteristics of another instrument. In some embodiments, the computer system 100 provides a carbon reflex index is implemented on a blockchain. An example blockchain 604 is shown by FIG. 6. The carbon reflex index includes a redemption value 112 that corresponds to a market value 108 of the carbon reflex index.

Carbon Synthetic Instruments, which grant users exposure to numerous carbon assets and/or financial derivatives (carbon futures and carbon options) while eliminating traditional barriers to entry, are among the latest forms of such innovation. In essence, Carbon Synthetics refer to the tokenized clone of traditional carbon-based financial assets. This ‘clone’ rests solely on a blockchain, however. Since they are blockchain-based, DeFi has become a home to these cryptographic assets. In fact, the integration of blockchain technology which brings automation and removes the need for intermediaries is what makes Carbon Synthetics so innovative. Courtesy of the blockchain, traders can enjoy exposure to traditional carbon allowances and offsets without the need to worry about the drawbacks a centralized platform brings. In addition, the decentralized nature of DeFi largely removes the troubles commonly emanated from regulatory bodies.

Similar to derivatives in traditional finance, Carbon Synthetics are digital cryptographic assets with their price pegged to other real-world carbon assets-such as EUAs and CCAs. Also referred to as “synths,” these cryptographic assets track and provide the returns of traditional assets without requiring access to the real-world carbon asset. Because the Carbon Synthetics disclosed herein are derivatives, their value is derived from an underlying asset through smart contracts. Therefore, these cryptographic assets can be used to trade the movement of price and value of traditional carbon assets. The stablecoins (e.g., cryptographic asset 116) can be created in the form of ERC-20 smart contracts that run initially on the Ethereum blockchain. They are different from options and other forms of traditional derivatives in that they tokenize the relationship between the derivative product and the underlying asset. Smart contracts are described in more detail with reference to FIG. 6.

Traditional derivatives are financial contracts that create terms for a carbon asset and its price. This allows DeFi users to leverage Carbon Synthetic cryptographic assets in the use of various trading strategies. For instance, hedging, which is a popular strategy in binary options trading, allows users to offset losses and manage risks by taking positions in derivatives. Such strategies can also be used in the Protocol world of Carbon Synthetic cryptographic assets described herein.

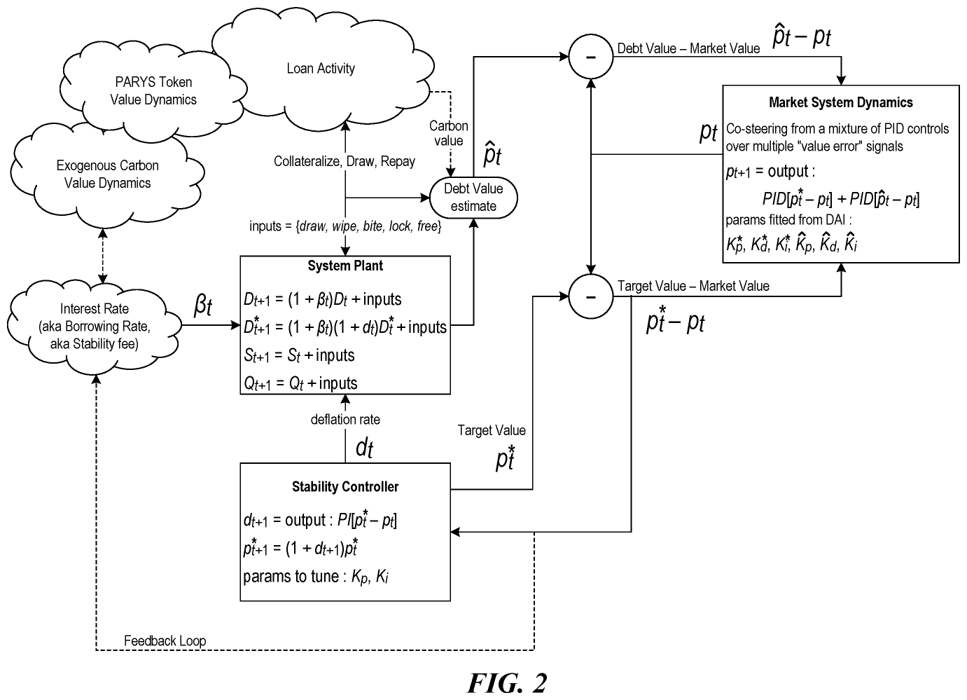

FIG. 2 is a block diagram illustrating an example system implementing a stablecoin, in accordance with one or more embodiments of this disclosure. An example stablecoin asset 116 is shown by FIG. 1. The shown by FIG. 2 can be implemented using the computer system 100 and/or components of example computer system 600 illustrated and described in more detail with reference to FIGS. 1 and 6. Likewise, embodiments of the system shown by FIG. 2 can include different and/or additional components or can be connected in different ways.

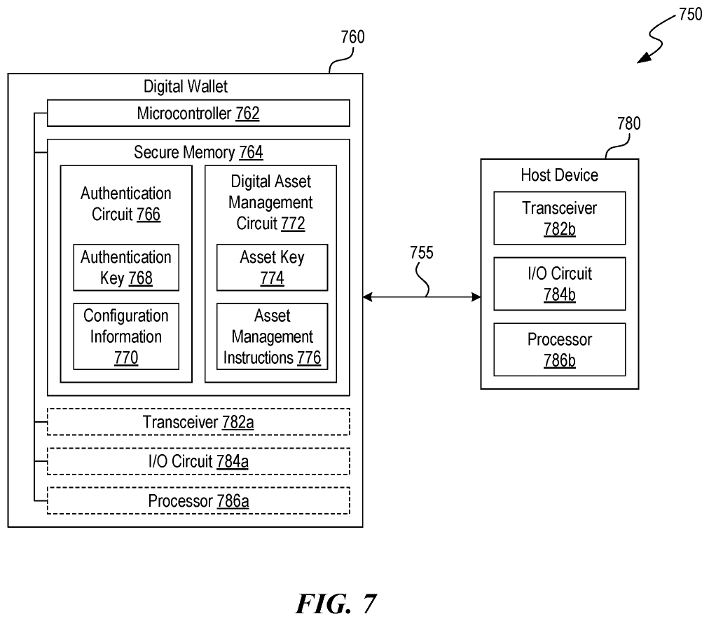

The Carbon Synthetic cryptographic assets disclosed herein carry a number of unique advantages. While there are no specific citizenship requirements to participate in the stock market, there are certain needs that investors must satisfy. Non-US persons must provide identification documents, pass Know Your Customer (KYC) screening, and comply with a number of laws that are intended to protect US interests. Carbon Synthetic cryptographic assets feasibly provide investors of any location or jurisdiction exposure to the price action of stocks, commodities, and currencies. To trade these tokens, users would hardly need any of the requirements to enter the US equities market. This makes Carbon Synthetic cryptographic assets a favorable alternative for foreign investors experiencing barriers to entry. Moreover, Carbon Synthetic cryptographic assets are openly tradeable and transferable, meaning anyone can send and receive them using standard crypto wallets. An example cryptographic wallet 760 is illustrated and described in more detail with reference to FIG. 7. Since DeFi is always on, synthetic tokens can be traded 24/7. This is in great contrast to traditional markets, where trading is limited to specific days and specific hours.

In addition, with Carbon Synthetic cryptographic assets, there are no central party restrictions or risks. The ethos of Carbon Synthetic cryptographic assets and decentralized finance (DeFi) lies in openness and transparency. Unlike traditional finance, DeFi does not rely on centralized authorities like banks or brokerages functioning as the intermediaries between transacting parties. Instead, a public ledger records and verifies transactions directly on a digital blockchain for all to reference, eliminating opacity and cumbersome bureaucracy. Since a centralized authority does not exist, investors are empowered with the autonomy to instantly access, trade, and transfer Carbon Synthetic cryptographic assets with ease.

DeFi works through smart contracts, which are automated, self-executed programs that cannot be altered. Once a certain set of requirements is met, the smart contract is automatically activated without the need for institutional intermediaries, thus removing any ambiguity in its terms. For example, a smart contract can be programmed to release salary funds for a bi-weekly payday or automatically issue payments to the winning party of a bet once the terms are met. By removing third parties, there is less room for missteps since issues of subjectivity and dishonesty are eliminated. The objective nature of smart contracts ensures that transactions are reliably fulfilled. By transitioning the concept of derivatives to DeFi in the form of Carbon Synthetic cryptographic assets, the possibility of global, borderless transactions becomes a reality, allowing anyone from anywhere to participate.

Carbon Synthetic cryptographic assets also allow investors to invest in new, emerging carbon commodity classes. For example, European Allowance Units (EUAs) have typically been only accessible by a handful of EU registered carbon brokers, but the Carbon Synthetics disclosed herein can bridge this gap. Through the tokenization of EUAs, anyone can buy into the token and reap the rewards of EU-ETS carbon allowance investing without ever personally needing to physically own or custody the EUAs directly. Unlike derivatives, Carbon Synthetics can earn rewards or yield by staking or holding on to a carbon asset for an extended period of time. For example, the Carbon Synthetic cryptographic asset (e.g., cryptographic asset 116) disclosed herein mimics the value of an underlying real-world carbon asset, in this case EUAs. By staking these Carbon Synthetics as collateral for projects, investors have the potential to earn interest. Moreover, the Carbon Synthetic equity strategy disclosed herein enables investors to maintain passive equity exposure while seeking a liquidity pool. Investors can generate an additional source of funds to enhance portfolio liquidity. Investors can further reduce foreign exchange risk because passive equity futures contracts minimize the foreign exchange risk associated with foreign equity holdings. Moreover, these contracts provide “cheap beta,” with low transaction costs and without the management fees and expenses associated with cash equity products. The cryptographic asset 116 generates higher portfolio yield because fixed income products can provide an additional and predictable source of portfolio income. In addition, the asset cryptographic 116 improves portfolio duration matching. Extending portfolio duration by adding carbon futures is especially useful for key rate duration matching for liability driven investors.

The Carbon Synthetic products disclosed herein are covered carbon allowances and carbon offsets, including derivatives such as futures and options, characterized by identical or similar profit and loss structures when compared with traditional carbon-based financial instruments. For example, the disclosed carbon investment services allow investors to decide on how much exposure they have to different forms of carbon assets, thereby allowing investors the ability to hedge risk associated with investing in carbon derivatives such as carbon futures and options. By investing in diversified portfolios containing weighted percentages of EUAs with EUA Futures, investors can achieve greater potential return-on-investment.

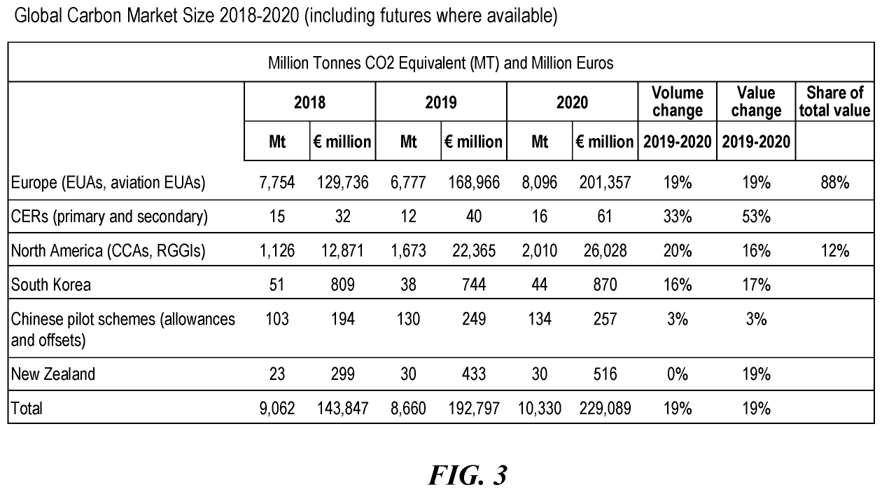

FIG. 3 is a table illustrating example trading volumes in carbon markets, in accordance with one or more embodiments of this disclosure. Carbon pricing mechanisms are becoming a ubiquitous part of the toolkit to tackle climate change. The higher the cost of a ‘permit’ or ‘allowance’ to produce carbon, the greater the incentive to implement abatement technology to reduce carbon output. There are several methods of achieving lower emissions, but the ‘cap and trade’ strategy is one of the most favored today. According to the World Bank, a total of 64 carbon pricing instruments are now in operation around the world, covering over 20% of global greenhouse gas (GHG) emissions and generating $53 billion in revenue.

The permits to produce greenhouse gases that are traded under the ETS are called Allowances (EUAs). The volume of trading in EUAs and futures based on EUAs is considerably larger than any other carbon market as shown by FIG. 3. The size and liquidity of this market offers investors and users the best trading experience. With the global carbon market being so fragmented, EUAs can provide a blueprint for a well-functioning cap and trade emission system. The EU-ETS is aided by a sizeable futures market which promotes the price discovery process so that carbon is correctly priced to reflect current policy ambitions.

The EU-ETS works on the ‘cap and trade’ principle. A cap is set on the total amount of certain greenhouse gases that can be emitted by the installations (or companies) covered by the system. The cap is reduced over time so that total emissions fall. Within the cap, companies buy or receive emissions allowances, which they can trade with one another as needed. Each allowance permits the holder to produce 1 ton of carbon equivalent greenhouse gases (tCO2e). The limit on the total number of allowances available ensures that they have a value. After each year, a company must surrender enough allowances to cover fully its emissions, otherwise heavy fines are imposed. The companies covered the scheme have a legal obligation to participate. If a company reduces its emissions, it can keep the spare allowances to cover its future needs or else sell them to another installation that is short of allowances. Trading brings flexibility that ensures emissions are cut where it costs least to do so. A robust carbon price also promotes investment in innovative, low-carbon technologies. Energy utilities, industrial emitters and intra-EU aircraft operators are the main types of companies covered today. Allowances are either auctioned or given to the emitters (known as free allocation). Historically, utilities have generally had to go through auction, while industrial emitters were largely given free allowances. More heavily emitting industrial companies may have to also go through auction to receive enough allowances to cover their activities. Aviation has had a separate track after its inclusion in 2012 and most of the allowances for this sector have historically been free allocation.

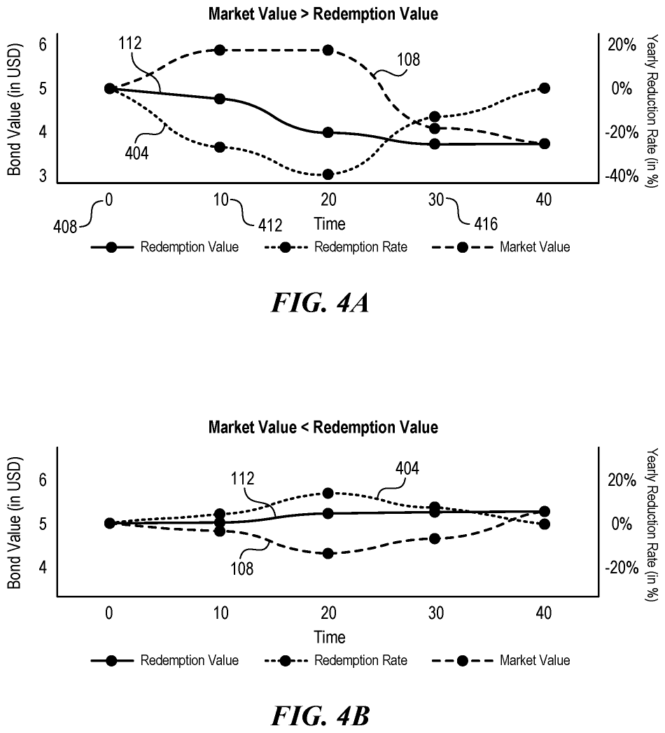

FIG. 4A is a graph illustrating an example relationship between market value 108 and redemption value 112, in accordance with one or more embodiments of this disclosure. An algorithmic controller can be embedded in a process and given control over a system input (e.g., computer system 100) in order to automatically update it based on deviations between the system output and a setpoint. In some embodiments, a proportional-integral-derivative (PID) controller (e.g., controller 104) is used.

A PID controller uses a mathematical formula with three parts to determine its output: Controller Output=Proportional Term+Integral Term+Derivative Term. The Proportional Term is the part of the controller which is directly proportional to the deviation. If the deviation is large and positive (e.g., a setpoint is far higher than the current value) the proportional response will be large and positive. The Integral Term is the part of the controller which takes into account how long a deviation has persisted. It is determined by taking the integral of the deviation over time and it is primarily used to eliminate steady state error. It accumulates in order to respond to small, albeit persistent deviations from the setpoint. The Derivative Term is the part of the controller which takes into account how fast the deviation is growing or shrinking. It is determined by taking the derivative of the deviation and serves to accelerate the controller response when the deviation is growing. It also helps reduce overshoot by decelerating the controller response when the deviation is shrinking. The combination of these three parts, each of which can be independently tuned, gives PID controllers great flexibility at managing a wide variety of control system applications.

PID controllers work well in systems that allow some degree of lag in the response time as well as the possibility of overshoot and oscillation around the setpoint as the system attempts to stabilize itself. The carbon reflex index systems (e.g., FIG. 2) disclosed herein are well suited for this type of scenario where their redemption value 112 can be changed by PID controllers.

For example, a Carbon Redemption Rate Feedback Mechanism used is the system component in charge of changing a carbon reflex index's redemption value 112. Carbon reflex index system participants may not respond directly to changes in the redemption value 112, but instead respond to the rate of change of the redemption value 112 (redemption rate 404). The redemption rate 404 is set by a feedback mechanism that governance can fine-tune or allow to be fully automated. The feedback mechanism disclosed here maintains equilibrium between the redemption value 108 and the market value 108 by using the redemption rate 404 to counter shifts in market forces. To achieve this, the redemption rate 404 is calculated so that it opposes the deviation between market and redemption prices. As shown by FIG. 4, if the carbon index's market value 108 is higher than its redemption value 112 (e.g., at time 412), the mechanism will calculate a negative rate which will start to decrease the redemption value 112, reducing the system's debt. The expectation of a decreasing redemption value 112 will likely discourage users from holding indexes and encourage SAFE holders to generate more debt (even if the collateral price does not change) which is then sold on the market, thus balancing out supply and demand.

FIG. 4B is a graph illustrating an example relationship between market value 108 and redemption value 112, in accordance with one or more embodiments of this disclosure. As shown by FIG. 4B, if the carbon index's market value 108 is lower than the redemption value 112, the redemption rate 404 becomes positive and starts to reprice all the debt so that it becomes more expensive. As debt becomes more expensive, the collateralization ratios of all SAFEs go down (thus SAFE creators are incentivized to pay back their debt) and users start to hoard carbon indexes with the expectation that they will increase in value.

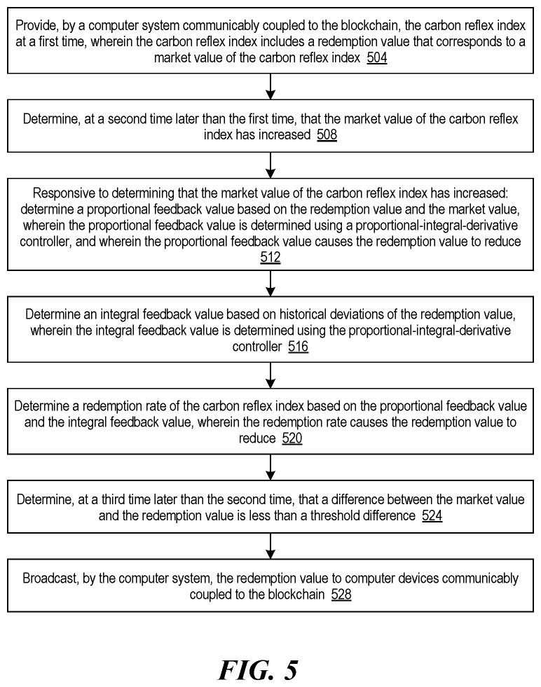

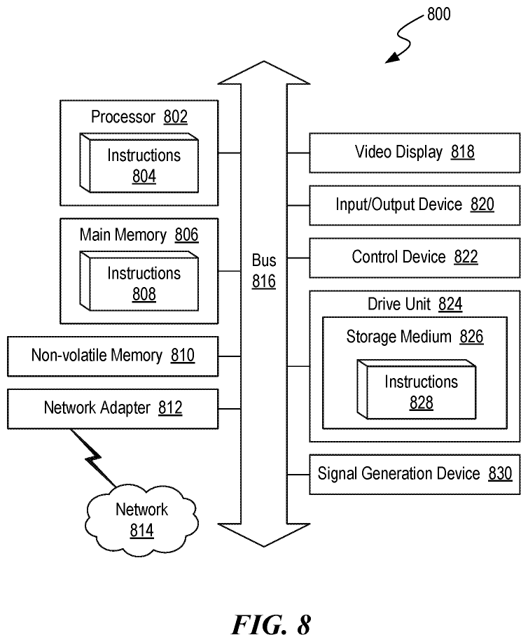

FIG. 5 is a flow diagram illustrating an example cryptographic computer-implemented process for operating a carbon reflex index implemented on a blockchain, in accordance with one or more embodiments of this disclosure. In some implementations, the process is performed by the computer system 100 illustrated and described in more detail with reference to FIG. 1. In some implementations, the process is performed by a computer system, e.g., example computer system 800 illustrated and described in more detail with reference to FIG. 8. Particular entities, for example, the blockchain system 600 perform some or all of the steps of the process in other implementations. The blockchain system 600 is illustrated and described in more detail with reference to FIG. 6. Likewise, implementations can include different and/or additional steps or can perform the steps in different orders.

At 504, a computer system that is communicably coupled to the blockchain provides the carbon reflex index at a first time (e.g., time 408 shown by FIG. 4A). The carbon reflex index is configured to dampen volatility of a native carbon collateral of the carbon reflex index. For example, the carbon reflex index's purpose is to dampen the volatility of its native carbon collateral. Indexes allow anyone to gain exposure to the cryptocurrency market without the same scale of risk as holding actual carbon assets. The carbon reflex index disclosed herein provides utility for other teams issuing carbon synthetics on Ethereum because it gives their systems a lower exposure to volatility of carbon assets and offers users more time to exit their positions in case of a significant market shift.

The carbon reflex index includes a redemption value (e.g., redemption value 112 shown by FIGS. 1 and 4A) that corresponds to a market value (e.g., market value 108 shown by FIGS. 1 and 4A) of the carbon reflex index. For example, the carbon reflex index is launched with an arbitrary redemption value, “rand.” The redemption value is of one debt unit (or coin) of cryptographic asset 116 in the system. The redemption value is an internal accounting tool and it is different from the market value (the value that the market is trading the coin at).

In some embodiments, the computer system or other computer devices mint a carbon-collateralized stablecoin based on a native carbon collateral of the carbon reflex index using proof-of-stake minting. An example stablecoin asset 116 is shown by FIG. 1. The proof-of-stake minting reduces greenhouse gas emissions compared to minting using digital mining. For example, for minting a carbon-collateralized stablecoin based on a native carbon collateral of the carbon reflex index using a proof-of-stake mechanism, the operation of the proof-of-stake mechanism reduces electrical power consumption and greenhouse gas emissions compared to operation of a proof-of-work mechanism or digital mining. Because reduced compute power is required for the proof of stake mechanism to function properly, a greater number of transactions can be validated while also using less power as compared to the proof of work mechanism. In fact, proof of stake transactions can be validated using computers with as little as 8 GB of RAM. This results in a drastic reduction in energy consumption per transaction. For example, proof-of-work mechanism can only conduct about five transactions per second, for an energy cost per transaction of 830 kWh. On the other hand, a proof-of-stake mechanism can conduct around 15 transactions per second, for an energy cost per transaction of 50 kWh.

In some embodiments, the computer system or other computer devices mint a carbon-collateralized stablecoin that is fungible with a carbon allowance.

At 508, the computer system determines, at a second time (e.g., time 412 shown by FIG. 4A) later than the first time, that the market value of the carbon reflex index has increased. For example, there can be a difference between the market value of a stablecoin and its redemption value. These scenarios create arbitrage opportunities where traders will create more coins if the market value is higher than redemption and they will redeem their stablecoins for collateral (e.g., US dollars in the case of USDC) in case the market value is lower than the redemption value. Carbon reflex indexes are similar to stablecoins because they also have a redemption value that the system targets. A difference in their case is that their redemption will not remain fixed, but is designed to change while being influenced by market forces.

At 512, in response to determining that the market value of the carbon reflex index has increased, the computer system determines a proportional feedback value based on the redemption value and the market value. The proportional feedback value is determined using a proportional-integral-derivative controller (e.g., stability controller 104 shown by FIG. 1). For example, the carbon index's market value rises from “rand” to “rand”+x. After the feedback mechanism reads the new market value, it calculates a proportional term p, which can be −1×((“rand”+x)÷“rand”). The proportional feedback value is negative in order to decrease the redemption value and in turn reprice the carbon indexes so that they become cheaper. The proportional feedback value causes the redemption value to reduce.

At 516, the computer system determines an integral feedback value based on historical deviations of the redemption value. The integral feedback value is determined using the proportional-integral-derivative controller. For example, after calculating the proportional feedback value, the mechanism will determine an integral term (i) by summing historical deviations from, e.g., the last deviationInterval seconds.

At 520, the computer system determines a redemption rate of the carbon reflex index based on the proportional feedback value and the integral feedback value. The redemption rate causes the redemption value to reduce. For example, the mechanism sums the proportional feedback value and the integral feedback value to determine a per-second redemption rate (r) that slowly starts to reduce the redemption value. As SAFE creators realize they can generate more debt, they will flood the market with more carbon indexes. For example, the proportional-integral-derivative controller is configured to maintain an equilibrium between the redemption value and the market value using the redemption rate. In some embodiments, an autonomous rate setter, a Carbon Allowance Index (CAI) Network Medianizer, is used that is integrated with many independent transparent from source value feeds implemented as a smart contract on ledger, as well as a governance minimization layer beyond RAI meant to isolate the system as much as possible from human intervention. Smart contracts are described in more detail with reference to FIG. 6.

At 524, the computer system determines, at a third time 416 later than the second time 412, that a difference between the market value and the redemption value is less than a threshold difference. For example, After n seconds, the mechanism detects that the deviation between the market and redemption values is negligible (under a specified parameter, noise). At this point, the algorithm sets r to zero and keeps the redemption value where it is. For example, determining that the difference between the market value and the redemption value is less than the threshold difference is performed at a third time 416 later than the second time 412.

At 528, the computer system broadcasts the redemption value to computer devices communicably coupled to the blockchain. For example, each computer device of the computer devices is configured to claim an amount of a native carbon collateral of the carbon reflex index based on the redemption value. Some variables can be rendered immutable (e.g., the noise parameter, deviationInterval), or strict bounds can be established over what governance can change. In addition, the functioning of the carbon reflex index system is based on tuning of the algorithmic controller parameters. The tuning process for a PID controller can include running the live system, tweaking the tuning parameters, and observing the system's response, often purposefully introducing shocks along the way. Here, computer modeling and simulation can be leveraged to set the initial parameters. Governance can update the tuning parameters if additional data from production shows them to be sub-optimal.

In some embodiments, the borrowing rate (interest rate applied when generating indexes) is fixed or capped and only the redemption value is adjusted, thus reducing the complexity involved in modeling the feedback mechanism. The borrowing rate can equal the spread between the stability fee and DSR in Multi-Collateral DAI. Although the borrowing rate can be fixed, it is possible to change it alongside the redemption value using a money market setter. The money market changes the borrowing rate and the redemption value in a way that incentivizes SAFE creators to generate more or less debt. If a carbon index's market price is above redemption, both rates will start to decrease, whereas if it is below redemption, the rates will increase. In some embodiments, global settlement is used to guarantee the redemption value to all carbon reflex index holders. It is meant to allow both carbon reflex index holders and SAFE creators to redeem system collateral at its net value (amount according to the latest redemption value). Settlement can have three main phases: (1) Trigger: settlement is triggered, users cannot create SAFEs anymore, all collateral price feeds and the redemption price are frozen and recorded; (2) Process: process all outstanding auctions; and (3) Claim: every carbon reflex index holder and SAFE creator can claim a fixed amount of any system collateral based on the index's last recorded redemption price.

In some embodiments, a Restricted Governance Module meant to delay or bound all possible system modifications is implemented. Moreover, a Governance Ice Age (a permissions registry that can lock some parts of the system from outside control after certain deadlines have passed) is implemented. Time Bounded Governance is a component of the Restricted Governance Module. It imposes time delays between changes applied to the same parameter. An example is the possibility to change the CAI smart contract inputs used as the overall carbon redemption price after at least T seconds have passed since the last CAI modification. Another component in the Restricted Governance Module is Action Bounded Governance. Every governable parameter has limits on what values it can be set to and how much it can change over a certain period of time. Notable examples are the initial versions of the Carbon Redemption Rate Feedback Mechanism that governance token holders will be able fine-tune.

The Governance Ice Age is an immutable smart contract that imposes deadlines on changing specific system parameters and on upgrading the protocol. It can be used in the case where governance wants to make sure they can fix bugs before the protocol locks itself and denies outside intervention. Ice Age will verify if a change is permitted by checking the parameter's name and the affected contract's address against a registry of deadlines. If the deadline has passed, the call will revert. Governance may be able to delay Ice Age a fixed number of times if bugs are found close to the date when the protocol should start to lock itself. For example, Ice Age can only be delayed three times, each time for one month, so that the newly implemented bug fixes are tested properly.

The areas where governance might be needed include adding new collateral diversification. The cryptographic assets 116 disclosed herein is backed only by native carbon instruments, and diversification will be achieved by adoption of new GHG Methodologies and GHG Projects approved for carbon collateral use to diversify risk over time. To change external dependencies, carbon indexes and DEXs that the system depends on can be upgraded. Governance can point the system to newer dependencies in order for it to continue functioning properly. For fine-tuning rate setters, early monetary policy controllers will have parameters that can be changed within reasonable bounds (as described by Action and Time Bounded Governance). For migrating between system versions, in some cases, governance can deploy a new system, give it permission to print protocol tokens and withdraw this permission from an old system. This migration is performed with the help of a Restricted Migration Module. For example, to migrate between system versions, a migration registry keeps track of how many different systems have the same token covers and which systems can be denied the permission to print tokens in a debt auction. Every time governance deploys a new system version, they submit the address of the system's debt auction contract in the migration registry. Governance also needs to specify if they will ever be able to stop the system from printing tokens. Also, governance can, at any time, say that one system will always be able to print tokens and thus it will never be migrated from. There is a cooldown period between proposing a new system and withdrawing permissions from an old one. An optional contract can be set up so that it automatically shuts down an old system after it is denied printing permissions. The migration module can be combined with an Ice Age that automatically gives specific systems the permission to always be able to print tokens.

There are cases that the system can automatically detect and as a result trigger settlement by itself, without the need to burn tokens. For example, when there are severe price feed delays, the system detects that one or more of the collateral or index price feeds have not been updated in a long time. To implement system migration, an optional contract can shut down the protocol after a cooldown period passes from the moment when governance withdraws the ability of the debt auction mechanism to print tokens. When there is consistent market price deviation, the system detects that the index's market price has been x % deviated for a long time compared to the redemption price. Governance will be able to upgrade these autonomous shutdown modules while still being bounded or until the Ice Age starts to lock some parts of the system.

In some embodiments, a carbon allowance index (CAI) is implemented. The three main asset types that the system needs to read price feeds for are the CAI, the token (cryptographic asset 116), and the collateralized assets (Carbon Allowances/Futures/FIAT). In limited cases, the price feeds can be provided by governance led CAIs or by already established CAI providers like the EU-ETS, the Intercontinental Exchange and IHS Markit. For governance-led CAI, the token holders or the core team that launched the protocol can partner with other entities who gather multiple CAI price feeds off-chain and then submit a single transaction to a smart contract that medianizes all data points. This approach allows for more flexibility on upgrading and changing the CAI infrastructure, although it comes at the expense of trustlessness.

A Carbon Allowance Index Network Medianizer (CAINM) is a smart contract that reads price indexes from multiple sources which are not directly controlled by governance (e.g., IceWeb, IHS Markit, and/or Uniswap V3 pool between an index collateral type and other tokens) and then medianizes all the results. The smart contracts disclosed herein keeps track of approved index feeds from networks it can call in order to request CAI values. The contract is funded by part of the surplus the system accrues. Each CAI network accepts payment so our contract also keeps track of the minimum amount and the type of tokens needed for each request.

In order to push a new price feed in the system, the CAI need to be called beforehand. When calling a CAI, the contract first swaps some stability fees with one of the CAI's accepted tokens. After a CAI is called, the contract tags the call as “valid” or “invalid”. If a call is invalid, the specific faulty CAI price feed network cannot be called again until all the other ones are called and the contract checks if there is a valid majority. A valid CAI call must not revert and it must retrieve a price that has been posted on-chain sometime in the last m seconds. “Retrieve” means different things depending on each CAI type. For a pull-based CAI, from which we can get a result right away, our contract needs to pay a fee and directly fetch the price. For a push-based CAI, our contract pays the fee, calls the CAI and needs to wait a specific period of time n before calling the CAI again in order to get the requested price.

Every CAI result is saved in an array. After every approved CAI is called and if the array has enough valid data points to form a majority (e.g., the contract received valid data from 3/5 CAI input networks), the results are sorted and the contract chooses the median. Whether the contract finds a majority or not, the array with CAI results is cleared and the contract will need to wait p seconds before starting the entire process all over again. Governance can add a backup CAI option that starts to push prices in the system if the CAI Medianizer cannot find a majority of valid approved networks several times in a row. The backup option must be set when the CAI Medianizer is deployed as it cannot be changed afterwards. Furthermore, a separate contract can monitor if the backup has been replacing the medianization mechanism for too long and automatically shut down the protocol.

In order to generate indexes, anyone can deposit and leverage their carbon collateral inside SAFEs. While a SAFE is opened, it will continue accruing debt according to the deposited collateral's borrowing rate. As the SAFE creator pays back their debt, they will be able to withdraw more and more of their locked collateral. There are four main steps needed for creating carbon reflex indexes and subsequently paying back a SAFE's debt. This first is to deposit collateral in the SAFE. The user first needs to create a new SAFE and deposit collateral in it. The second is to generate indexes backed by the SAFE's collateral. The user specifies how many indexes they want to generate. The system creates an equal amount of debt that starts to accrue according to the collateral's borrowing rate. The third is to pay back the SAFE debt. When the SAFE creator wants to withdraw their collateral, they have to pay back their initial debt plus the accrued interest. The fourth is to withdraw collateral. After the user pays back some or all of their debt, they are allowed to withdraw their collateral.

In order to keep the system solvent and cover the value of the entire outstanding debt, each SAFE can be liquidated in case its collateralization ratio falls under a certain threshold. Anyone can trigger a liquidation; in which case the system will confiscate the SAFE's collateral and sell it off in a collateral auction. In one version of the system, SAFE creators can have the option to choose a trigger for when their SAFEs get liquidated. Triggers are smart contracts that automatically add more collateral in a SAFE and potentially save it from liquidation. Examples of triggers are contracts that sell short positions or contracts that communicate with insurance protocols such as Nexus Mutual, or carbon specific insurance programs like the Global Carbon Trust. Another method to protect SAFEs is the addition of two different collateralization thresholds: safe and risk. SAFE users can generate debt until they hit the safe threshold (which is higher than risk) and they only get liquidated when the SAFE's collateralization goes below the risk threshold.

To begin a carbon collateral auction, the system needs to use a variable called liquidationQuantity in order to determine the amount of debt to be covered by every auction and the corresponding amount of collateral to be sold. A liquidation penalty will be applied to every auctioned SAFE. A fixed discount auction is a straightforward way (compared to English auctions) to put collateral up for sale in exchange for system coins used to settle bad debt. Bidders are only required to allow the auction house to transfer their safeEngine.coinBalance and can then call buyCollateral in order to exchange their system coins for collateral which is sold at a discount compared to its latest recorded market price. Bidders can also review the amount of collateral they can get from a specific auction by calling getCollateralBought or getApproximateCollateralBought. Note that getCollateralBought is not marked as view because it reads (and also updates) the redemptionPrice from the CAI relayer whereas getApproximateCollateralBought uses the lastReadRedemptionPrice.

In the scenario where a collateral auction cannot cover all the bad debt in a SAFE and if the system does not have any surplus reserves, anyone can trigger a debt auction. Debt auctions are meant to mint more protocol tokens and sell them for indexes that can nullify the system's remaining bad debt. In order to start a debt auction, the system needs to use two parameters (1) initialDebtAuctionAmount: the initial amount of protocol tokens to mint post-auction; and (2) debtAuctionBidSize: the initial bid size (how many indexes must be offered in exchange for initialDebtAuctionAmount protocol tokens).

The initial amount of protocol tokens minted in a debt auction can either be set through a governance vote or it can be automatically adjusted by the system. An automated version would need to be integrated with CAIs from which the system would read the protocol token and carbon reflex index market prices. The system would then set the initial amount of protocol tokens (initialDebtAuctionAmount) that will be minted for debtAuctionBidSize indexes. An initialDebtAuctionAmount can be set at a discount compared to the actual PROTOCOL/INDEX market price in order to incentivize bidding.

As opposed to collateral auctions, debt auctions only have one stage: decreaseSoldAmount (uint id, uint amountToBuy, uint bid): decrease the amount of protocol tokens accepted in exchange for a fixed number of indexes. The auction will be restarted if it has no bids placed. Every time it restarts, the system will offer more protocol tokens for the same number of indexes. The new protocol token amount is calculated as lastTokenAmount*amountSoldIncrease/100. After the auction settles, the system will mint tokens for the highest bidder.

As described herein, each protocol will need to be protected by a token that is minted through debt auctions. Apart from protection, the token will be used to govern a few system components. Also, the protocol token supply will gradually be reduced with the use of surplus auctions. The amount of surplus that needs to accrue in the system before extra funds are auctioned is called the surplusBuffer and it is automatically adjusted as a percentage of the total debt issued.

Apart from the protocol token, governance can create an insurance fund that holds a wide array of uncorrelated assets and which can be used as a backstop for debt auctions. This fund can optionally facilitate purchase of carbon insurance through the Global Carbon Trust program. Surplus auctions sell stability fees accrued in the system for protocol tokens that are then burned.

FIG. 6 is a block diagram illustrating components of at least a portion of an example blockchain system 600 that can be used to implement the methods described herein. Blockchain system 600 includes blockchain 604. In embodiments, the blockchain 604 is a distributed ledger of transactions (e.g., a continuously growing list of records, such as records of transactions for digital assets such as cryptocurrency, bitcoin, or electronic cash) that is maintained by a blockchain system 600. For example, the blockchain 604 is stored redundantly at multiple nodes (e.g., computers) of a blockchain network. Each node in the blockchain network can store a complete replica of the entirety of blockchain 604. In some embodiments, the blockchain system 600 implements storage of an identical blockchain at each node, even when nodes receive transactions in different orderings. The blockchain 604 shown by FIG. 6 includes blocks such as block 604a, block 604b, and/or block 604c. Likewise, embodiments of the blockchain system 600 can include different and/or additional components or be connected in different ways.

The terms “blockchain” and “chain” are used interchangeably herein. In embodiments, the blockchain 604 is a distributed database that is shared among the nodes of a computer network. As a database, the blockchain 604 stores information electronically in a digital format. The blockchain 604 can maintain a secure and decentralized record of transactions (e.g., transactions such as transaction 624a and/or transaction 624b). For example, the ERC-721 or ERC-1155 standards are used for maintaining a secure and decentralized record of transactions. The blockchain 604 provides fidelity and security for the data record. In embodiments, blockchain 604 collects information together in groups, known as “blocks” (e.g., blocks such as block 604a, block 604b, and/or block 604c) that hold sets of information.

The blockchain 604 structures its data into chunks (blocks) (e.g., blocks such as block 604a, block 604b, and/or block 604c) that are strung together. Blocks (e.g., block 604c) have certain storage capacities and, when filled, are closed and linked to a previously filled block (e.g., block 604b), forming a chain of data known as the “blockchain.” New information that follows a freshly added block (e.g., block 604b) is compiled into a newly formed block (e.g., block 604c) that will then also be added to the blockchain 604 once filled. The data structure inherently makes an irreversible timeline of data when implemented in a decentralized nature. When a block is filled, it becomes a part of this timeline of blocks. Each block (e.g., block 604a) in the blockchain system 600 is given an exact timestamp (e.g., timestamp 612a) when it is added to the blockchain system 600. In the example of FIG. 6, blockchain system 600 includes multiple blocks. Each of the blocks (e.g., block 604a, block 604b, block 604c) can represent one or multiple transactions and can include a cryptographic hash of the previous block (e.g., previous hashes 608a-c), a timestamp (e.g., timestamps 612a-c), a transactions root hash (e.g., 616a-c), and a nonce (e.g., 620a-c). A transactions root hash (e.g., transactions root hash 616b) indicates the proof that the block 604b contains all the transactions in the proper order. Transactions root hash 616b proves the integrity of transactions in the block 604b without presenting all transactions.

In embodiments, the timestamp 612a-c of each of corresponding blocks of block 604a, block 604b, block 604c includes data indicating a time associated with the block. In some examples, the timestamp includes a sequence of characters that uniquely identifies a given point in time. In one example, the timestamp of a block includes the previous timestamp in its hash and enables the sequence of block generation to be verified.

In embodiments, nonces 620a-c of each of corresponding blocks of block 604a, block 604b, block 604c include any generated random or semi-random number. The nonce can be used by miners during proof of work (PoW), which refers to a form of adding new blocks of transactions to blockchain 604. The work refers to generating a hash that matches the target hash for the current block. For example, a nonce is an arbitrary number that miners (e.g., devices that validate blocks) can change in order to modify a header hash and produce a hash that is less than or equal to the target hash value set by the network.

As described above, each of blocks of block 604a, block 604b, block 604c of blockchain 604 can include respective block hash, e.g., transactions root hash 616a, transactions root hash 616b, and transactions root hash 616c. Each of block hashes 616a-c can represent a hash of a root node of a Merkle tree for the contents of the block (e.g., the transactions of the corresponding block). For example, the Merkle tree contains leaf nodes corresponding to hashes of components of the transaction, such as a reference that identifies an output of a prior transaction that is input to the transaction, an attachment, and a command. Each non-leaf node can contain a hash of the hashes of its child nodes. The Merkle tree can also be considered to have each component as the leaf node with its parent node corresponding to the hash of the component.

In the example of FIG. 6, block 604b records transactions 624a-d. Each of the leaf nodes 628a-d contain a hash corresponding to transactions 624a-d respectively. As described above, a hash (e.g., the hash in leaf node such as node 628a) can be a hash of components of a transaction (e.g., transaction 624a), for example, a reference that identifies an output of a prior transaction that is input to the transaction 624a, an attachment, and a command. Each of the non-leaf nodes of node 632a and node 632b can contain a hash of the hashes of its child nodes (e.g., leaf nodes such as node 628a and node 628b). In this example, node 632a can contain a hash of the hashes contained in node 628a, node 628b and node 632b can contain a hash of the hashes contained in node 628c, node 628d. The root node, which includes (e.g., contains) transactions root hash 616b, can contain a hash of the hashes of child nodes 632a-b.

A Merkle tree representation of a transaction (e.g., transaction 624a) allows an entity needing access to the transaction 624a to be provided with only a portion that includes the components that the entity needs. For example, if an entity needs only the transaction summary, the entity can be provided with the nodes (and each node's sibling nodes) along the path from the root node to the node of the hash of the transaction summary. The entity can confirm that the transaction summary is that used in the transaction 624a by generating a hash of the transaction summary and calculating the hashes of the nodes along the path to the root node. If the calculated hash of the root node matches the hash of node 628a of the transaction 624a, the transaction summary is confirmed as the one used in the transaction. Because only the portion of the Merkle tree relating to components that an entity needs is provided, the entity will not have access to other components. Thus, the confidentiality of the other components is not compromised.

To transfer ownership of a digital asset, such as a bitcoin, using the blockchain system 600, a new transaction, such as one of transactions 624a-d, is generated and added to a stack of transactions in a block, e.g., block 604b. To record a transaction in a blockchain, each party and asset involved with the transaction needs an account that is identified by a digital token. For example, when a first user wants to transfer an asset that the first user owns to a second user, the first and second user both create accounts, and the first user also creates an account that is uniquely identified by the asset's identification number. The account for the asset identifies the first user as being the current owner of the asset. The first user (i.e., the current owner) creates a transaction (e.g., transaction 624a) against the account for the asset that indicates that the transaction 624a is a transfer of ownership and outputs a token identifying the second user as the next owner and a token identifying the asset. The transaction 624a is signed by the private key of the first user (i.e., the current owner), and the transaction 624a is evidence that the second user is now the new current owner, and that ownership has been transferred from the first to the second user.

The transaction 624a (e.g., a new transaction), which includes the public key of the new owner (e.g., a second user to whom a digital asset is assigned ownership in the transaction), is digitally signed by the first user with the first user's private key to transfer ownership to the second user (e.g., new owner), as represented by the second user public key. The signing by the owner of the bitcoin is an authorization by the owner to transfer ownership of the bitcoin to the new owner via the transaction 624a (e.g., the new transaction). Once the block is full, the block is “capped” with a block header, that is, a hash digest of all the transaction identifiers within the block. The block header is recorded as the first transaction in the next block in the chain, creating a mathematical hierarchy called the “blockchain.” To verify the current owner, the blockchain 604 of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

Additionally, in some embodiments, the blockchain system 600 uses one or more smart contracts to enable more complex transactions. A smart contract includes computer code implementing transactions of a contract. The computer code can be executed on a secure platform (e.g., an Ethereum platform, which provides a virtual machine) that supports recording transactions (e.g., 624a-d) in blockchains. For example, a smart contract can be a self-executing contract with the terms of the agreement between buyer and seller being directly written into lines of code. The code and the agreements contained therein exist across a distributed, decentralized blockchain network.

In addition, the smart contract can itself be recorded as a transaction 624a in the blockchain 604 using a token that is a hash of node 628a of the computer code so that the computer code that is executed can be authenticated. When deployed, a constructor of the smart contract executes, initializing the smart contract and its state. The state of a smart contract is stored persistently in the blockchain 604. When a transaction 624a is recorded against a smart contract, a message is sent to the smart contract, and the computer code of the smart contract executes to implement the transaction (e.g., debit a certain amount from the balance of an account). The computer code ensures that all the terms of the contract are complied with before the transaction 624a is recorded in the blockchain 604.

For example, a smart contract can support the sale of an asset. The inputs to a smart contract to sell an asset can be tokens identifying the seller, the buyer, the asset, and the sale price in U.S. dollars or cryptocurrency. The computer code is used to ensure that the seller is the current owner of the asset and that the buyer has sufficient funds in their account. The computer code records a transaction (e.g., transaction 624a) that transfers the ownership of the asset to the buyer and a transaction (e.g., transaction 624b) that transfers the sale price from the buyer's account to the seller's account. If the seller's account is in U.S. dollars and the buyer's account is in Canadian dollars, the computer code can retrieve a currency exchange rate, determine how many Canadian dollars the seller's account should be debited, and record the exchange rate. If either of transaction 624a or transaction 624b is not successful, neither transaction is recorded.

When a message is sent to a smart contract to record a transaction 624a, the message is sent to each node that maintains a replica of the blockchain 604. Each node executes the computer code of the smart contract to implement the transaction 624a. For example, if a hundred nodes each maintain a replica of the blockchain 604, the computer code executes at each of the hundred nodes. When a node completes execution of the computer code, the result of the transaction 624a is recorded in the blockchain 604. The nodes employ a consensus algorithm to decide which transactions (e.g., transaction 624c) to keep and which transactions (e.g., transaction 624d) to discard. Although the execution of the computer code at each node helps ensure the authenticity of the blockchain 604, large amounts of computer resources are required to support such redundant execution of computer code.

Although blockchains can effectively store transactions 624a-d, the large amount of computer resources, such as storage and computational power, needed to maintain all the replicas of the blockchain can be problematic. To overcome this problem, some systems for storing transactions 624a-d do not use blockchains, but rather have each party to a transaction maintain its own copy of the transaction 624a. One such system is the Corda™ system developed by R3™ that provides a decentralized distributed ledger platform in which each participant in the platform has a node (e.g., computer system) that maintains its portion of the distributed ledger.

When parties agree on the terms of a transaction 624a, a party submits the transaction 624a to a notary, which is a trusted node, for notarization. The notary maintains a consumed output database of transaction outputs that have been input into other transactions. When a transaction 624a is received, the notary checks the inputs to the transaction 624a against the consumed output database to ensure that the outputs that the inputs reference have not been spent. If the inputs have not been spent, the notary updates the consumed output database to indicate that the referenced outputs have been spent, notarizes the transaction 624a (e.g., by signing the transaction or a transaction identifier with a private key of the notary), and sends the notarized transaction to the party that submitted the transaction 624a for notarization. When the party receives the notarized transaction, the party stores the notarized transaction and provides the notarized transaction to the counterparties.

In embodiments, a notary is a non-validating notary or a validating notary. When a non-validating notary is to notarize a transaction (e.g., transaction 624b), the non-validating notary determines that the prior output of a prior transaction (e.g., transaction 624a), that is, the input of a current transaction, e.g., transaction 624b, has not been consumed. If the prior output has not been consumed, the non-validating notary notarizes the transaction 624b by signing a hash of node 628b of the transaction. To notarize a transaction 624b, a non-validating notary needs only the identification of the prior output (e.g., the hash of node 628a of the prior transaction (e.g., transaction 624a) and the index of the output) and the portion of the Merkle tree needed to calculate the hash of node 628b of the transaction 624b.

As described herein, in some embodiments, the blockchain system 600 uses one or more smart contracts to enable more complex transactions. For example, a validating notary validates a transaction (e.g., transaction 624d), which includes verifying that prior transactions 624a-c in a backchain of transactions are valid. The backchain refers to the collection of prior transactions (e.g., transaction 624c) of a transaction 624d, as well as prior transactions of transaction 624a, transaction 624b, and transaction 624c, and so on. To validate a transaction 624d, a validating notary invokes validation code of the transaction 624d. In one example, a validating notary invokes validation code of a smart contract of the transaction 624d. The validation code performs whatever checks are needed to comply with the terms applicable to the transaction 624d. This checking can include retrieving the public key of the owner from the prior transaction (e.g., transaction 624c) (pointed to by the input state of the transaction 624d) and checks the signature of the transaction 624d, ensuring that the prior output of a prior transaction that is input has not been consumed, and checking the validity of each transaction (e.g., transaction 624c) in the backchain of the transactions. If the validation code indicates that the transaction 624d is valid, the validating notary notarizes the transaction 624d and records the output of the prior transaction (e.g., transaction 624c) as consumed.

In some examples, to verify that the transactions 624a-d in a ledger stored at a node are correct, the blocks, e.g., block 604a, block 604b, block 604c in the blockchain 604 can be accessed from oldest block (e.g., block 604a) to newest block (e.g., block 604c), generating a new hash of the block 604c and comparing the new hash to the hash 608c generated when the block 604c was created. If the hashes are the same, then the transactions in the block are verified. In one example, the Bitcoin system also implements techniques to ensure that it would be infeasible to change a transaction 624a and regenerate the blockchain 604 by employing a computationally expensive technique to generate a nonce 620b that is added to the block when it is created. A bitcoin ledger is sometimes referred to as an Unspent Transaction Output (“UTXO”) set because it tracks the output of all transactions that have not yet been spent.

In some embodiments, a self-sovereign identity (SSI) approach to digital identity is used that gives individuals control over the information they use to prove who they are to websites, services, and applications across the web. In an SSI system, the user accesses services in a streamlined and secure manner, while maintaining control over the information associated with their identity. SSI addresses the difficulty of establishing trust in an interaction. In order to be trusted, one party in an interaction will present credentials to the other parties, and those relying on parties can verify that the credentials came from an issuer that they trust. In this way, the verifier's trust in the issuer is transferred to the credential holder. This basic structure of SSI with three participants is sometimes called “the trust triangle”. For an identity system to be self-sovereign, users control the verifiable credentials that they hold, and their consent is required to use those credentials. This reduces the unintended sharing of users' personal data.

In an SSI system, holders generate, and control unique identifiers called decentralized identifiers. Most SSI systems are decentralized, where the credentials are managed using crypto wallets and verified using public-key cryptography anchored on a distributed ledger. The credentials may contain data from an issuer's database, a social media account, a history of transactions on an e-commerce site, or attestation from friends or colleagues.

FIG. 7 is a block diagram illustrating an example system 750 including a cryptographic wallet 760 that can be used to store at least some of the assets described herein. As a general overview, cryptographic wallet 760 is an electronic entity that allows users to securely manage digital assets. According to various embodiments, the cryptographic wallet 760 can be a hardware-based wallet (e.g., can include dedicated hardware component(s)), a software-based wallet, or a combination thereof. Example digital assets that can be stored and managed using the cryptographic wallet 760 include digital coins, digital tokens, and/or the like. In some embodiments, tokens are stored on a blockchain system, such as the blockchain system 600 described in FIG. 6. In some embodiments, the cryptographic wallet 760 may be capable of connecting to and managing assets that are native to or associated with multiple, different blockchain systems (e.g., including multiple blockchain systems having structure similar to or equivalent to blockchain system 600).

As defined herein, the terms “coin” and “token” refer to a digital representation of a particular asset, utility, ownership interest, and/or access right. Any suitable type of coin or token can be managed using various embodiments of the cryptographic wallet 760. In some embodiments, tokens include cryptocurrency, such as exchange tokens and/or stablecoins. Exchange tokens and/or stablecoins can be native to a particular blockchain system and, in some instances, can be backed by a value-stable asset, such as fiat currency, precious metal, oil, or another commodity. An example stablecoin asset 116 is shown by FIG. 1. In some embodiments, tokens are utility tokens that provide access to a product or service rendered by an operator of the blockchain system 600 (e.g., a token issuer). In some embodiments, tokens are security tokens, which can be securitized cryptocurrencies that derive from a particular asset, such as bonds, stocks, real estate, and/or fiat currency, or a combination thereof, and can represent an ownership right in an asset or in a combination of assets.

In some embodiments, tokens are NFTs or other non-fungible digital certificates of ownership. In some embodiments, tokens are decentralized finance (DeFi) tokens. DeFi tokens can be used to access feature sets of DeFi software applications (dApps) built on the blockchain system 600. Example dApps can include decentralized lending applications (e.g., Aave), decentralized cryptocurrency exchanges (e.g., Uniswap), decentralized NFT marketplaces (e.g., OpenSea, Rarible), decentralized gaming platforms (e.g., Upland), decentralized social media platforms (e.g., Steemit), decentralized music streaming platforms (e.g., Audius), and/or the like. In some embodiments, tokens provide access rights to various computing systems and can include authorization keys, authentication keys, passwords, PINs, biometric information, access keys, and other similar information. The computing systems to which the tokens provide access can be both on-chain (e.g., implemented as dApps on a particular blockchain system) or off-chain (e.g., implemented as computer software on computing devices that are separate from the blockchain system 600).

As shown, the cryptographic wallet 760 of FIG. 7 is communicatively coupled to the host device 780 (e.g., a mobile phone, a laptop, a tablet, a desktop computer, a wearable device, a point-of-sale (POS) terminal, an automated teller machine (ATM) and the like) via the communications link 755. In some embodiments, the host device 780 can extend the feature set available to the user of the cryptographic wallet 760 when it is coupled to the host device 780. For instance, the host device may provide the user with the ability to perform balance inquiries, convert tokens, access exchanges and/or marketplaces, perform transactions, access computing systems, and/or the like.

In some embodiments, the cryptographic wallet 760 and the host device 780 can be owned and/or operated by the same entity, user, or a group of users. For example, an individual owner of the cryptographic wallet 760 may also operate a personal computing device that acts as a host device 780 and provides enhanced user experience relative to the cryptographic wallet 760 (e.g., by providing a user interface that includes graphical features, immersive reality experience, virtual reality experience, or similar). In some embodiments, the cryptographic wallet 760 and the host device 780 can be owned and/or operated by different entities, users and/or groups of users. For example, the host device 780 can be a point-of-sale (POS) terminal at a merchant location, and the individual owner of the cryptographic wallet 760 may use the cryptographic wallet 760 as a method of payment for goods or services at the merchant location by communicatively coupling the two devices for a short period of time (e.g., via chip, via near-field communications (NFC), by scanning of a bar code, by causing the cryptographic wallet 760 to generate and display a quick response (QR) code, and/or the like) to transmit payment information from the cryptographic wallet 760 to the host device 780.

The cryptographic wallet 760 and the host device 780 can be physically separate and/or capable of being removably coupled. The ability to uncouple the cryptographic wallet physically and communicatively 760 from the host device 780 and other devices enables the air-gapped cryptographic wallet (e.g., cryptographic wallet 760) to act as “cold” storage, where the stored digital assets are moved offline and become inaccessible to the host device 780 and other devices. Further, the ability to uncouple the cryptographic wallet physically and communicatively 760 from the host device 780 allows the cryptographic wallet 760 to be implemented as a larger block of physical memory, which extends the storage capacity of the cryptographic wallet 760, similar to a safety deposit box or vault at a brick-and-mortar facility.

Accordingly, in some embodiments, the cryptographic wallet 760 and the host device 780 are physically separate entities. In such embodiments, the communications link 755 can include a computer network. For instance, the cryptographic wallet 760 and the host device 780 can be paired wirelessly via a short-range communications protocol (e.g., Bluetooth, ZigBee, infrared communication) or via another suitable network infrastructure. In some embodiments, the cryptographic wallet 760 and the host device 780 are removably coupled. For instance, the host device 780 can include a physical port, outlet, opening, or similar to receive and communicatively couple to the cryptographic wallet 760, directly or via a connector.

In some embodiments, the cryptographic wallet 760 includes tangible storage media, such as a dynamic random-access memory (DRAM) stick, a memory card, a secure digital (SD) card, a flash drive, a solid state drive (SSD), a magnetic hard disk drive (HDD), or an optical disc, and/or the like and can connect to the host device via a suitable interface, such as a memory card reader, a USB port, a micro-USB port, an eSATA port, and/or the like.

In some embodiments, the cryptographic wallet 760 can include an integrated circuit, such as a SIM card, a smart cart, and/or the like. For instance, in some embodiments, the cryptographic wallet 760 can be a physical smart card that includes an integrated circuit, such as a chip that can store data. In some embodiments, the cryptographic wallet 760 is a contactless physical smart card. Advantageously, such embodiments enable data from the card to be read by a host device as a series of application protocol data units (APDUs) according to a conventional data transfer protocol between payment cards and readers (e.g., ISO/IEC 7816), which enhances interoperability between the cryptographic payment ecosystem and payment card terminals.

In some embodiments, the cryptographic wallet 760 and the host device 780 are non-removably coupled. For instance, various components of the cryptographic wallet 760 can be co-located with components of the host device 780 in the housing of the host device 780. In such embodiments, the host device 780 can be a mobile device, such as a phone, a wearable, or similar, and the cryptographic wallet 760 can be built into the host device. The integration between the cryptographic wallet 760 and the host device 780 can enable improved user experience and extend the feature set of the cryptographic wallet 760 while preserving computing resources (e.g., by sharing the computing resources, such as transceiver, processor, and/or display or the host device 780). The integration further enables the ease of asset transfer between parties. The integration can further enhance loss protection options, as recovering a password or similar authentication information, rather than recovering a physical device, can be sufficient to restore access to digital assets stored in the cryptographic wallet 760. In some embodiments, the non-removably coupled cryptographic wallet can be air-gapped by, for example, disconnecting the host device 780 from the Internet.

As shown, the cryptographic wallet 760 can include a microcontroller 762. The microcontroller 762 can include or be communicatively coupled to (e.g., via a bus or similar communication pathway) at least a secure memory 764. The cryptographic wallet 760 can further include a transceiver 782a, and input/output circuit 784a, and/or a processor 786a. In some embodiments, however, some or all of these components can be omitted.

In some embodiments, the cryptographic wallet 760 can include a transceiver 782a and therefore can be capable of independently connecting to a network and exchanging electronic messages with other computing devices. In some embodiments, the cryptographic wallet 760 does not include a transceiver 782a. The cryptographic wallet 760 can be capable of connecting to or accessible from a network, via the transceiver 782b of the host device 780, when the cryptographic wallet 760 is docked to the host device 780. For example, in some embodiments, the user of the cryptographic wallet 760 can participate in token exchange activities on decentralized exchanges when the cryptographic wallet 760 is connected to the host device 780.

In some embodiments, the cryptographic wallet 760 can include an input/output circuit 784a, which may include user-interactive controls, such as buttons, sliders, gesture-responsive controls, and/or the like. The user-interactive controls can allow a user of the cryptographic wallet 760 to interact with the cryptographic wallet 760 (e.g., perform balance inquiries, convert tokens, access exchanges and/or marketplaces, perform transactions, access computing systems, and/or the like). In some embodiments, the user can access an expanded feature set, via the input/output circuit 784b of the host device 780, when the cryptographic wallet 760 is docked to the host device 780. For example, host device 780 can include computer-executable code structured to securely access data from the secure memory 764 of the cryptographic wallet 760 and to perform operations using the data. The data can include authentication information, configuration information, asset keys, and/or token management instructions. The data can be used by an application that executes on or by the host device 780. The data can be used to construct application programming interface (API) calls to other applications that require or use the data provided by cryptographic wallet 760. Other applications can include any on-chain or off-chain computer applications, such as dApps (e.g., decentralized lending applications, decentralized cryptocurrency exchanges, decentralized NFT marketplaces, decentralized gaming platforms, decentralized social media platforms, decentralized music streaming platforms), third-party computing systems (e.g., financial institution computing systems, social networking sites, gaming systems, online marketplaces), and/or the like.

The secure memory 764 is shown to include an authentication circuit 766 and a digital asset management circuit 772. The authentication circuit 766 and/or digital asset management circuit 772 include computer-executable code that, when executed by one or more processors, such as one or more processors of processor 786a and/or processor 786b, performs specialized computer-executable operations. For example, the authentication circuit 766 can be structured to cause the cryptographic wallet 760 to establish, maintain and manage a secure electronic connection with another computing device, such as the host device 780. The digital asset management circuit 772 can be structured to cause the cryptographic wallet 760 to allow a user to manage the digital assets accessible via the cryptographic wallet 760. In some embodiments, the authentication circuit 766 and the digital asset management circuit 772 are combined in whole or in part.

As shown, the authentication circuit 766 can include retrievably stored security, authentication, and/or authorization data, such as the authentication key 768. The authentication key 768 can be a numerical, alphabetic, or alphanumeric value or combination of values. The authentication key 768 can serve as a security token that enables access to one or more computing systems, such as the host device 780. For instance, in some embodiments, when the cryptographic wallet 760 is paired or docked to (e.g., establishes an electronic connection with) the host device 780, the user may be prompted to enter authentication information via the input/output circuit(s) of input/output circuit 784a and/or input/output circuit 784b. The authentication information may include a PIN, a password, a pass phrase, biometric information (e.g., fingerprint, a set of facial features, a retinal scan), a voice command, and/or the like. The authentication circuit 766 can compare the user-entered information to the authentication key 768 and maintain the electronic connection if the items match at least in part.

As shown, the authentication circuit 766 can include retrievably stored configuration information such as configuration information 770. The configuration information 770 can include a numerical, alphabetic, or alphanumeric value or combination of values. These items can be used to enable enhanced authentication protocols. For instance, the configuration information 770 can include a timeout value for an authorized connection between the cryptographic wallet 760 and the host device 780. The configuration information 770 can also include computer-executable code. In some embodiments, for example, where a particular cryptographic wallet, such as cryptographic wallet 760, is set up to pair with only one or a small number of pre-authorized host devices such as host device 780, the configuration information 770 can include a device identifier and/or other device authentication information, and the computer-executable code may be structured to verify the device identifier and/or other device authentication information against the information associated with or provided by the host device 780. When a pairing is attempted, the computer-executable code may initiate or cause the host device 780 to initiate an electronic communication (e.g., an email message, a text message, etc.) using user contact information stored as configuration information 770.

As shown, the digital asset management circuit 772 can include retrievably stored digital asset data, such as the asset key 774. The asset key 774 can be a numerical, alphabetic, or alphanumeric value or combination of values. In some embodiments, the asset key 774 is a private key in a public/private key pair, a portion thereof, or an item from which the private key can be derived. Accordingly, the asset key 774 proves ownership of a particular digital asset stored on a blockchain system 600. The asset key 774 can allow a user to perform blockchain transactions involving the digital asset. The blockchain transactions can include computer-based operations to earn, lend, borrow, long/short, earn interest, save, buy insurance, invest in securities, invest in stocks, invest in funds, send and receive monetary value, trade value on decentralized exchanges, invest and buy assets, sell assets, and/or the like. The cryptographic wallet 760 can be identified as a party to a blockchain transaction on the blockchain system 600 using a unique cryptographically generated address (e.g., the public key in the public/private key pair).

As shown, the digital asset management circuit 772 can also include retrievably stored asset management instructions such as asset management instructions 776. The asset management instructions 776 can include a numerical, alphabetic, or alphanumeric value or combination of values. These items can be used to enable computer-based operations related to managing digital assets identified by the asset key 774. For instance, the asset management instructions 776 can include parameter values, metadata, and/or similar values associated with various tokens identified by the asset key 774 and/or by the blockchain system 600 associated with particular tokens. The asset management instructions 776 can also include computer-executable code. In some embodiments, for example, asset management functionality (e.g., balance inquiry and the like) can be executable directly from the cryptographic wallet 760 rather than or in addition to being executable from the host device 780.

FIG. 8 is a block diagram illustrating an example computer system 800, in accordance with one or more embodiments. In some embodiments, components of the example computer system 800 are used to implement the blockchain system 600 or the computer system 100 illustrated and described in more detail with reference to FIGS. 1 and 6. At least some operations described herein can be implemented on the computer system 800.

The computer system 800 can include one or more central processing units (“processors”) such as one or more processors 802, and can further include main memory 806, non-volatile memory 810, network adapter 812 (e.g., network interface), video displays 818, input/output devices 820, control devices 822 (e.g., keyboard and pointing devices), drive units 824 including a storage medium 826, and a signal generation device 830 that are communicatively connected to a bus 816. The bus 816 is illustrated as an abstraction that represents one or more physical buses and/or point-to-point connections that are connected by appropriate bridges, adapters, or controllers. The bus 816, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1294 bus (also referred to as “Firewire”).

The computer system 800 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 800.

While the main memory 806, non-volatile memory 810, and storage medium 826 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 828. The term “machine-readable medium” and “storage medium” shall also be taken to include any medium that is capable of storing, encoding, or carrying a set of instructions for execution by the computer system 800.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 804, 808, 828) set at various times in various memory and storage devices in a computer device. When read and executed by the one or more processors 1302, the instruction(s) cause the computer system 800 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and/or non-volatile memory 810, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 812 enables the computer system 800 to mediate data in a network 814 with an entity that is external to the computer system 800 through any communication protocol supported by the computer system 800 and the external entity. The network adapter 812 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 812 can include a firewall that governs and/or manages permission to access proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

The functions performed in the processes and methods can be implemented in differing order. Furthermore, the outlined steps and operations are only provided as examples, and some of the steps and operations can be optional, combined into fewer steps and operations, or expanded into additional steps and operations without detracting from the essence of the disclosed embodiments.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms can on occasion be used interchangeably.

### Terms

Accounting Engine: system component which triggers debt and surplus auctions. It also keeps track of the amount of currently auctioned debt, unactioned bad debt and the surplus buffer.
Borrowing Rate: annual interest rate applied to all SAFEs that have outstanding debt.
Carbon Allowances—also called “emissions trading schemes”, or “cap and trade”—are sometimes described as the economist's solution to greenhouse gas emissions. They are tradeable government permits that allow polluters to pump carbon dioxide (CO2) into the atmosphere. Under these programs, polluters must surrender enough allowances to cover their pollution upon inspection. Governments ensure compliance, with large fines issued for non-compliance.
Carbon Allowance Index (CAI): the external carbon futures contract index used for price discovery, fungibility, and redemption price in the PARYS™ protocol. This index should map to the carbon market PARYS™ is bound to for price discovery, fungibility and collateral redemption, initially the EU-ETS market with the ICEEUA carbon index. Other versions of PARYS™ may bind to other carbon markets in a similar capacity.
Carbon Allowance Index Network Medianizer (CAINM): a smart contract that pulls prices from multiple approved carbon pricing sources, and medianizes them if a majority (e.g., 3 out of 5) returned a result without throwing, or on-network redundancy.
Carbon Futures: are derivative financial contracts that obligate parties to buy or sell a carbon allowance at a predetermined future date and price. The buyer must purchase or the seller must sell the underlying carbon allowance at the set price, regardless of the current market price at the expiration date.
Carbon Reflex index: a collateralized asset that dampens the volatility of its underlying carbon collateral.
Carbon Synthetic: a Synthetic Instrument as defined by the International Financial Reporting Standards (IFRS) herein, utilizing carbon allowances, carbon offsets, carbon futures, carbon options, or any form of carbon asset or derivative available in any manner as a structured financial instrument.
Emissions Trading Scheme (ETS): an Emissions Trading Scheme works on the ‘cap and trade’ principle. A cap is set on the total amount of certain greenhouse gases that can be emitted by the installations covered by the system. The cap is reduced over time so that total emissions fall. Within the cap, installations buy or receive emissions allowances, which they can trade with one another as needed. The limit on the total number of allowances available ensures that they have a value. After each year, an installation must surrender enough allowances to cover fully its emissions, otherwise heavy fines are imposed. If an installation reduces its emissions, it can keep the spare allowances to cover its future needs or else sell them to another installation that is short of allowances. Trading brings flexibility that ensures emissions are cut where it costs least to do so. A robust carbon price also promotes investment in innovative, low-carbon technologies.
European Union-Emissions Trading Scheme (EU-ETS): the European Union's cap and trade carbon market implementation.
Governance Ice Age: immutable contract that locks most components of a protocol from outside intervention after a certain deadline has passed.
Money Market Setter (MMS): a mechanism similar to RRFM which pulls multiple monetary levers at once. In the case of carbon reflex indexes, it modifies both the borrowing rate and the redemption price.
PARYS™: the first carbon reflex index as a stable Carbon Synthetic.
Pigouvian Subsidy: a subsidy that is used to encourage behavior that have positive effects on others who are not involved or society at large. Behaviors or actions that are a benefit to others who are not involved in the transaction are called positive externalities. This is closely related to the idea of a pigouvian tax.
RAI: the first reflex index.
Redemption Price: the price that the system wants the index to have. It changes, influenced by a redemption rate (computed by RRFM), in case the market price is not close to it. Meant to influence SAFE creators to generate more or pay back some of their debt.
Redemption Rate Feedback Mechanism (RRFM): an autonomous mechanism which compares the market and redemption prices of a carbon reflex index and then computes a redemption rate that slowly influences SAFE creators to generate more or less debt (and implicitly tries to minimize the market/redemption price deviation).
Restricted Governance Module (RGM): a set of smart contracts that bound the power that governance tokens holders have over the system. It either enforces time delays or limits the possibilities that governance has to set certain parameters.
Stablecoin: a digital asset, on a blockchain, that is designed to maintain a consistent value, typically by linkage to the value of another asset. Presently, there are 4 ways to design a stablecoin:
Algorithmic (derives value from a separate token specific to the stablecoin)
Commodity Collateralized (derives value from a commodity, e.g., Gold)
Cryptocurrency Collateralized (derives value from other cryptocurrencies, e.g., ETH, BTC)
Fiat Collateralized (derives value from a fiat currency, e.g., USD, EUR)
PARYS™ can act as a stablecoin in current crypto exchanges consistent with the 2nd category, carbon (commodity) collateralized.
Structured Financial Instrument: comprises of a range of products designed to repackage and redistribute risk. They are pre-packaged investments based on a single security, a basket of securities, options, commodities, debt issuance or foreign currencies, and to a lesser extent, derivatives. They include asset-backed securities (ABS) and collateralized debt obligations (CDOs).
Surplus Buffer: amount of interest to accrue and keep in the system. Any interest accrued above this threshold gets sold in surplus auctions that burn protocol tokens.
Surplus Treasury: contract that gives permission to different system modules to withdraw accrued interest (e.g., CAINM for carbon pricing index calls).
Synthetic Instrument: According to the International Financial Reporting Standards (IFRS), a synthetic instrument is a financial product designed, acquired, and held to emulate the characteristics of another instrument. For example, such is the case of a floating-rate long-term debt combined with an interest rate swap. This involves receiving floating payments, or making fixed payments, thereby synthesizing a fixed-rate long-term debt. Another example of a synthetic is the output of an option strategy followed by dealers who are selling synthetic futures for a commodity that they hold by using a combination of put and call options. By simultaneously buying a put option in a given commodity, say, gold, and selling the corresponding call option, a trader can construct a position analogous to a short sale in the commodity's futures market.

Alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

I/We claim:

1. A cryptographic computer-implemented method for operating a carbon reflex index implemented on a blockchain, the method comprising:
providing, by a computer system communicably coupled to the blockchain, the carbon reflex index at a first time,
wherein the carbon reflex index includes a redemption value that corresponds to a market value of the carbon reflex index;
determining, at a second time later than the first time, that the market value of the carbon reflex index has increased;
responsive to determining that the market value of the carbon reflex index has increased:
determining a proportional feedback value based on the redemption value and the market value,
wherein the proportional feedback value is determined using a proportional-integral-derivative controller, and
wherein the proportional feedback value causes the redemption value to reduce;
determining an integral feedback value based on historical deviations of the redemption value,
wherein the integral feedback value is determined using the proportional-integral-derivative controller;
determining a redemption rate of the carbon reflex index based on the proportional feedback value and the integral feedback value,
wherein the redemption rate causes the redemption value to reduce;
determining, at a third time later than the second time, that a difference between the market value and the redemption value is less than a threshold difference; and
broadcasting, by the computer system, the redemption value to computer devices communicably coupled to the blockchain.

2. The cryptographic computer-implemented method of claim 1, wherein the carbon reflex index is configured to dampen volatility of a native carbon collateral of the carbon reflex index.

3. The cryptographic computer-implemented method of claim 1, wherein the proportional-integral-derivative controller is configured to maintain an equilibrium between the redemption value and the market value using the redemption rate.

4. The cryptographic computer-implemented method of claim 1, wherein each computer device of the computer devices is configured to claim an amount of a native carbon collateral of the carbon reflex index based on the redemption value.

5. The cryptographic computer-implemented method of claim 1, comprising minting a carbon-collateralized stablecoin based on a native carbon collateral of the carbon reflex index using a proof-of-stake mechanism,
wherein operation of the proof-of-stake mechanism reduces electrical power consumption and greenhouse gas emissions compared to operation of a proof-of-work mechanism or digital mining.

6. The cryptographic computer-implemented method of claim 1, comprising minting a carbon-collateralized stablecoin that is fungible with a carbon allowance.

7. A computer system comprising:
one or more computer processors; and
a non-transitory computer-readable memory storing instructions, which when executed by the one or more computer processors cause the computer system to:
provide a carbon reflex index is implemented on a blockchain,
wherein the carbon reflex index includes a redemption value that corresponds to a market value of the carbon reflex index;
determine that the market value of the carbon reflex index has increased;
determine a proportional feedback value based on the redemption value and the market value;
determine an integral feedback value based on historical deviations of the redemption value;
determine a redemption rate of the carbon reflex index based on the proportional feedback value and the integral feedback value;
determine that a difference between the market value and the redemption value is less than a threshold difference; and
broadcast the redemption value to computer devices communicably coupled to the blockchain.

8. The computer system of claim 7, wherein the carbon reflex index is provided at a first time, and
wherein determining that the market value of the carbon reflex index has increased is performed at a second time later than the first time.

9. The computer system of claim 8, wherein determining that the difference between the market value and the redemption value is less than the threshold difference is performed at a third time later than the second time.

10. The computer system of claim 7, wherein the proportional feedback value is determined using a proportional-integral-derivative controller.

11. The computer system of claim 7, wherein the proportional feedback value causes the redemption value to reduce.

12. The computer system of claim 7, wherein the integral feedback value is determined using a proportional-integral-derivative controller.

13. The computer system of claim 7, wherein the redemption rate causes the redemption value to reduce.

14. The computer system of claim 7, wherein the carbon reflex index is configured to dampen volatility of a native carbon collateral of the carbon reflex index.

15. The computer system of claim 7, wherein a proportional-integral-derivative controller is configured to maintain an equilibrium between the redemption value and the market value using the redemption rate.

16. The computer system of claim 7, wherein each computer device of the computer devices is configured to claim an amount of a native carbon collateral of the carbon reflex index based on the redemption value.

17. The computer system of claim 7, wherein the instructions cause the computer system to mint a carbon-collateralized stablecoin based on a native carbon collateral of the carbon reflex index.

18. The computer system of claim 7, wherein the instructions cause the computer system to mint a carbon-collateralized stablecoin that is fungible with a carbon allowance.

19. A non-transitory, computer-readable storage medium storing computer instructions, which when executed by one or more computer processors cause the one or more computer processors to:
provide a carbon reflex index is implemented on a blockchain,
wherein the carbon reflex index includes a redemption value that corresponds to a market value of the carbon reflex index;
determine that the market value of the carbon reflex index has increased;
determine a proportional feedback value based on the redemption value and the market value;
determine an integral feedback value based on historical deviations of the redemption value;
determine a redemption rate of the carbon reflex index based on the proportional feedback value and the integral feedback value;
determine that a difference between the market value and the redemption value is less than a threshold difference; and
broadcast the redemption value to computer devices communicably coupled to the blockchain.

20. The non-transitory, computer-readable storage medium of claim 19, wherein the proportional feedback value is determined using a proportional-integral-derivative controller.
